(19) United States
(12) Patent Application Publication
(10) Pub. No.: US 2020/0061450 A1
(43) Pub. Date: Feb. 27, 2020

(54) SIDE BET FOR CRAPS GAME WITH SPECIAL MARKINGS FOR RUNNING COUNT

(71) Applicant: Kyle Dennis Morris, Temecula, CA (US)

(72) Inventor: Kyle Dennis Morris, Temecula, CA (US)

(21) Appl. No.: 16/109,695

(22) Filed: Aug. 22, 2018

(51) Int. Cl. A63F 3/00; G07F 17/32

(52) U.S. Cl. CPC A63F 3/00157; A63F 2003/00164; G07F 17/3288; G07F 17/3244

(57) ABSTRACT

A method of executing a side bet wagering event during multiple rounds of play in a dice game selected from craps or Sic Bo games in which:
a) a player places a side bet wager before a round of play in the dice game;
b) the side bet wager indicating a specific player making the wager with a marker indicating a position within the multiple rounds of play in the dice game;
c) the side bet wager being resolved by outcomes in 2-7 casts of dice during the multiple rounds of play in the dice game, at least one winning outcome paid against a paytable for achieving a cumulative total of exactly twenty-one with two dice in craps or a higher number than twenty-one (such as 30-36) with three dice in Sic Bo from the outcomes in from 2-7 casts during the multiple rounds of play in the dice game.

### BACKGROUND OF THE INVENTION

### 1. Field of the Invention

The present invention relates to the field of gaming, particularly table gaming and more particularly table gaming using dice in an underlying game such as craps or Sic Bo.

### 2. Background of the Art

Dice games are one of the oldest forms of gaming entertainment, and recently they have made a resurgence in casino table gaming environments. There are basically two major gaming events using dice, craps and Sic Bo.

Craps is one of the oldest forms of wagering, and is based upon rigid probabilities for the occurrence of specific combinations of dice faces being exposed after a roll. There are 36 possible combinations of dice faces that may appear in the roll of two dice with six faces identified with values of 1, 2, 3, 4, 5, and 6. The combinations of values or count (and number of combinations that provide those values) are 2(1), 3(2), 4(3), 5(4), 6(5), 7(6), 8(5), 9(4), 10(3), 11(2) and 12(1). This statistical breakdown shows there are thirty-six (36) combinations of dice, and the probabilities of events assists in determining the odds provided by the house on each throw of the dice and the overall odds and house hold percentage on every wager made at the craps table. The available wagers have been known for many years, and few additional wagers or additional table displays have been added to standard craps games over the years. One of the few newer additions to craps table displays (printing on the surface of the felt table top) has been the provision of specific boxes for placement of hopping bets at the table. The boxes consist of a box for every dice combination (except 1-1, 1-2, 6-5 and 6-6, which are, in effect, hopping bets and have available betting boxes on the table) where wagers can be placed on that specific event. The nature of wagering at the craps table will be described in greater detail in the Detailed Description of the Invention.

If the player throws a preselected winning combination, such as a 4-5-6, triple, or pair and a 6, the shooter wins. If the shooter throws a preselected losing combination, such as a 1-2-3 or a pair and a one, the shooter loses. If the shooter throws a third combination, such as a pair and a 2-3-4 or 5, then the player throws in an attempt to beat the shooter. If the player throws a preselected combination, such as a 4-5-6, or a pair and single die having a value higher than that of the shooter, the player wins. If the player throws a preselected loser, such as a 1-2-3, or a pair and single die having a value less than that of the shooter, the player loses. If the player or shooter does not throw one of above stated winning or losing combinations, then the shooter or player must throw again. Each player may place a second bet that the outcome of the game will result in predetermined winning die combination yielding a predetermined winning payout. A player may also place bonus bet means, wherein if that particular throw results in a preselected combination, such as triple sixes, the player is entitled to a throw. If the player throws another preselected combination, such as a triple six, the player is entitled to a large winning payout.

U.S. Pat. No. 5,487,547 describes a wagering method and betting table for craps with a progressive bet or jackpot bet provided for a specific number and type of consecutive doubles being rolled. Specifically, the progressive wager is for doubles 2, 4, 6, 8, 10 and 12 being rolled in any order with no other rolls being present.

U.S. Pat. No. 5,490,670 describes a layout and method of play of the game of craps wherein a pair of dice is used, the dice being of a size for manually rolling to present one of eleven different numbers which define a plurality of point numbers, at least one natural number, and at least one craps number. A gaming layout provides a flat surface upon which said dice may be rolled and upon which bets may be laid by physical placement of wagers, said flat surface including indicia thereon representing a plurality of wager areas, said wager areas including: (a) a pass line area for receiving a wager betting both (i) that one or more rolls of dice will yield an established first point number without rolling the number “7”; and (ii) that a natural number is rolled prior to establishing the first point number or prior to rolling a craps number; (b) a don't pass area for receiving a wager betting both (i) that one or more rolls of the dice will yield the number “7” prior to the rolling of an established first point number; and (ii) that a craps number is rolled prior to establishing the first point number or prior to rolling a natural number; and (c) a jackpot area for receiving a wager that a set of a plurality of dice outcomes are rolled, said set having a remote probability of occurrence, and said set being randomly generated at a certain point in the play.

U.S. Pat. No. 5,728,002 describes a craps game is disclosed that incorporates a jackpot wagering area in a traditional craps game. In the jackpot wagering area, a player may make a bet that covers multiple wagers, including at least one jackpot sequence wager that a jackpot sequence of dice outcomes will be rolled. The jackpot sequence has a relatively remote possibility of occurrence and, correspondingly, a high payoff. A jackpot wagering area bet covers wagers in addition to the jackpot sequence wager. For example, the bet may also cover an additional jackpot sequence wager, a lower payoff sequence wager, or a traditional craps wager.

U.S. Pat. No. 5,829,749 describes a method of playing a craps game is disclosed that incorporates a jackpot wagering area in a traditional craps game. The method includes receiving a bet that a jackpot sequence of dice outcomes will be rolled. The jackpot sequence has a relatively remote possibility of occurrence and, correspondingly, a high payoff. A jackpot wagering area bet may cover wagers in addition to the jackpot sequence wager. For example, the bet may also cover an additional jackpot sequence wager, a lower payoff sequence wager, or a traditional craps wager. Also, the method of playing a craps game with a jackpot sequence wager may be played on a video screen.

U.S. Pat. No. 6,655,689 describes a proposition bet for Craps referred to as a FIRE BET™ The method includes predetermining a schedule of a pay-out table, players placing FIRE BET™ wagers at respective player betting areas prior to a shooter's initial come out; accumulating points responsive to outcomes of the shooter's dice throws, wherein points are made when a number 4, 5, 6, 8, 9 or 10 is twice rolled before sevening out, and wherein repeating of any made number is ignored, and making a pay-out based upon the points accumulated and the schedule.

U.S. Pat. No. 8,540,240 (Golden) evidences a casino craps table layout is provided with unique wagering opportunities. There are specific wagering areas for placing a wager on at least one of two new wagering opportunities. These new wagering opportunities are selected from the group consisting of a) a wager that the next roll of the dice will be a hard 4, 6, 8 or 10 and b) a wager that the next roll of the dice will be a pair of numbers. Another new wagering opportunity is a placed wager for any specific number (e.g., 4, 5, 6, 8, 9, and 10).

Sic Bo, meaning “dice pair” is an ancient Chinese gambling game. It is very popular in Macau, in my estimation second to baccarat only. In the United States is often found in the Asian gaming rooms, especially in Atlantic City. The large Las Vegas properties will usually have one table in the general casino.

The game uses three dice and a table with a variety of betting options on the roll of those dice. The odds and table layout may also vary from place to place. However, the payoffs are the same across Atlantic City and Macau, but different from each other. In Vegas and on the Internet casinos, anything is possible.

Following is a list of the bets available. The payoffs vary on some bets, from casino to casino, so for those bets a range of viable payoffs is indicated.

Small: Wins on total of 4-10, except for a three of a kind. Probability of winning is 48.61%. Pays 1 to 1. House edge is 2.78%.

Big: Wins on total of 11-17, except for a three of a kind. Probability of winning is 48.61%. Pays 1 to 1. House edge is 2.78%. Total of 4 and 17: Pays 50 to 1 in Macau, 60 to 1 in Atlantic City, and 62 to 1 in Australia.

Total of 5 and total of 16: Pays 18 to 1 in Macau, 30 to 1 in Atlantic City, and 31 to 1 in Australia.

It would be desirable to add additional wagers and especially additional proposition wagers to the play at a dice table to add interest and excitement to the game, to increase potential winnings or house hold, and to advance the game of craps or Sic Bo.

### SUMMARY OF THE INVENTION

A method of executing a side bet wagering event during multiple rounds of play in a dice game selected from craps or Sic Bo games in which:
a) a player places a side bet wager before a round of play in the dice game;
b) the side bet wager indicating a specific player making the wager with a marker indicating a position within the multiple rounds of play in the dice game;
c) the side bet wager being resolved by outcomes in 2-7 casts of dice during the multiple rounds of play in the dice game, at least one winning outcome paid against a paytable for achieving a cumulative total of exactly twenty-one with two dice in craps or a higher number than twenty-one (such as 30-36) with three dice in Sic Bo from the outcomes in from 2-7 casts during the multiple rounds of play in the dice game.

### BRIEF DESCRIPTION OF THE FIGURES

FIG. 1 shows a casino dice table display in a craps game after a first cast or roll of the dice.

FIG. 2 shows a casino dice table display in a craps game after a second cast or roll of the dice.

FIG. 3 shows a casino dice table display in a craps game after a third cast or roll of the dice and a winning outcome.

FIG. 4 shows a casino dice table display in a craps game after a second cast or roll of the dice provides a total count which is a losing outcome as its total cannot act in the next roll outcome to provide a winning outcome according to the rules.

FIG. 5 shows a craps table with a display element disposed for view by all players at the craps table for outcomes in a side bet wagering event according to the present invention.

FIG. 6 shows a lammer or virtual lammer display system for use according to the present gaming technology.

FIG. 7 shows a display panel for an alternative or additional super event side bet accounting display.

FIG. 8 shows a display panel for a further alternative or additional super event side bet accounting display.

### DETAILED DESCRIPTION OF THE INVENTION

A method of executing a side bet wagering event during multiple rounds of play in a dice game selected from craps or Sic Bo games in which:
a) a player places a side bet wager before a round of play in the dice game;
b) the side bet wager indicates a specific player making the side bet wager by placement of a marker or a lighted display on a game table indicating a position from which the side bet wager becomes active within the multiple rounds of play in the dice game;
c) the side bet wager is resolved by outcomes in 2-7 casts of dice during the multiple rounds of play in the dice game. At least one winning outcome pays against a paytable for achieving a cumulative total of exactly twenty-one with two dice in craps or a higher number than twenty-one (such as 30-36) with three dice in Sic Bo game from the total of individual game event outcomes in the 2-7 casts during the multiple rounds of play in the dice game.

In one method of executing a side bet wagering event during multiple rounds of play in a casino dice game such as a craps game or Sic Bo game:
a) a player places a side bet before a round of play (either a first round when the player enters the game, or at any other round designated a first round by a marker or indication within the gaming system) in a casino dice game;
b) the side bet wager is indicated on the gaming table by identifying an amount of the side bet wager, a specific player making the wager and a position within the multiple rounds of play in the casino craps game;

This can be implemented with any of an electronic display panel positioned at each player position or in a central location, both of which are controlled by the pit crew (e.g., croupier, cashier, pit boss) or a combination of physical and electronic indicators. For example, in craps there may be a specific marking on a game table displaying individual play event outcomes of 2, 3, 4, 5, 6, 7, 8, 9, 10, 11 and 12. Player positions may have additional side bet wager positions of 1, 2, 3, 4, 5, 6, 7 and 8 or may be provided with unique player position markers of like number, with unique markings for each player position. When a player decides to make a wager on the side bet event (which in craps will be referenced as 21-Craps™), that will indicate a first sequence of event outcomes for that player on which a wager is placed. If it is a first wager running at that time, it will be identified as a first wager, as with a unique player marker noted as “1” for that player being placed at an appropriate position on the table, such as the first position at the wager positions of 1, 2, 3, 4, 5, 6, 7 and 8 markers. If only a single denomination wager is allowed (e.g., only $10.00) that unique player marker may be added alone. If ranges of wagers on the side bet are allowed, that unique player marker is placed with a regular denomination chip (e.g., $1.00, $5.00, $$25.00 etc.) or multiple chips above or below the unique player marker.
c) the side bet wager being resolved by outcomes in from 2-7 casts of dice during the multiple rounds of play in the casino craps game, at least one winning outcome paid against a paytable for achieving a cumulative total of exactly twenty-one from the outcomes in from 2-7 casts of dice during the multiple rounds of play in the casino craps game.

After an outcome on the first cast of the dice in craps with the side bet wager being placed, the house will indicate a first subtotal for the running cumulative count of under the side bet wager. The running total for the first side bet wager could be indicated by a light display (having individual values of, for example. 1-3, 1-4, 1-5, 1-6, 1-7 or 1-8) or lammer, both of which are controlled by the crew at the gaming table, by electronic entry by the drew or by physical placement of a lammer, For example, if the first cast of the dice in craps had an event outcome total of 9, the light display or lammer would indicate a number ‘1” by the physical and electronic indicator for “9” within the specific marking or electronic display on the game table displaying individual play event outcomes of 2, 3, 4, 5, 6, 7, 8, 9, 10, 11 and 12 (the only possible dice outcomes with two dice).

After an outcome on the second cast of the dice in craps with the side bet wager being placed, the running total for the first side bet wager could be indicated by a light display or the same lammer, indicating either the total of the cumulative total for the first and second die cast outcome. For example, if the second cast had an event outcome of “6,” the cumulative total would be “15” and the lammer noted as “1” would be moved to the current total of “15.” At this point, the side bet wager is still in play, as further dice event outcomes in craps could still total “21” from further casts of the two dice. Depending on underlying game rules and selected paytable, the occurrence of a total of “21” in two event outcomes could be a winning outcome, with an immediate and final payout on the side bet wager, or a loss (or a push) if the paytable requires at least or exactly three individual game outcome cumulative totals to be exactly “21.”

After an outcome on the third cast of the dice in craps with the side bet wager being placed, the running total for the first side bet wager could be indicated by a light display or the same lammer indicating either the total of the cumulative total for the first and second and third cumulative die cast outcome. For example, if the first cast had an event outcome of 9 and if the second cast had an event outcome of “6” and the third cast had an outcome of “6,” that would be a winning event as the cumulative total would be “21” and the lammer noted as “1” would be moved to the final total of “21.” At this point, the side bet wager is no longer in play, as further dice event outcomes in craps could not still total “21” from further casts of the two dice. If the cumulative total was over 21, the side bet game would be over, with the player losing. If the cumulative total were “20,” the game would also be over, as no further cast of two dice can be lower than or equal to “21.” If the third cast produced a cumulative total point count of 19 or less, and the game rules allow for more than four casts, the side bet gaming event will continue to conclusions.

In the method, identification may be made by a special marker on a gaming table being used during the multiple rounds of play in the casino craps game to indicate when a specific player places a side bet before a specific round of play during the multiple rounds of play in the casino craps game. The count total system indicates running totals for more than one consecutive round of play at a single time. The cumulative total of exactly twenty-one from the outcomes may be required in the paytable to be the cumulative result in exactly 2, 3 and/or 4 casts of dice during the multiple rounds of play in the casino craps game. The paytable may also include an award for a cumulative total of exactly 21 by three consecutive casts having a total of exactly 7 with each cast.

The multiple rounds of play in the casino craps game may be executed with number, each specific cast outcome. The multiple rounds of play in the casino craps game on an electronic gaming table in which either physical dice are automatically cast or virtual dice are virtually cast and a panel marker indicates, by number, each specific cast outcome.

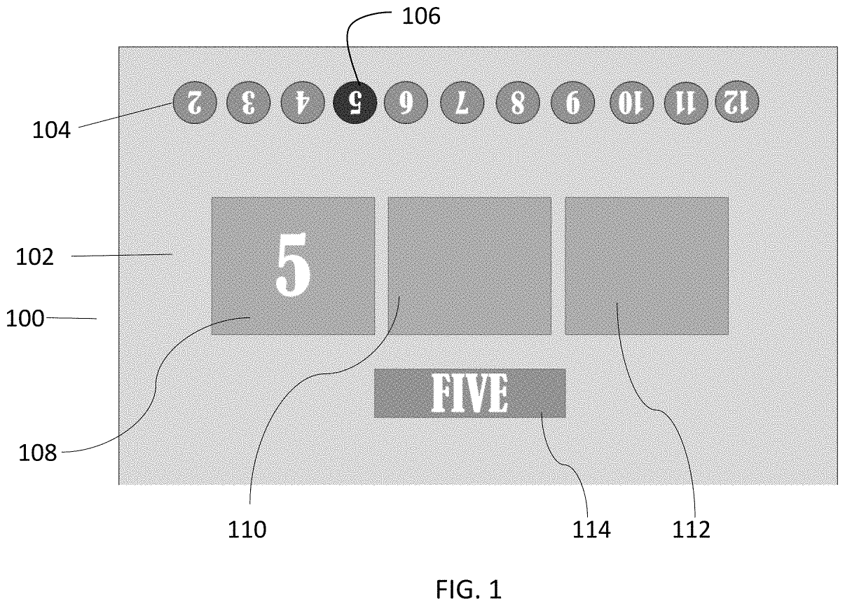

FIG. 1 shows a casino dice table display 100 having a first display area 102 for all side bet outcome information. The casino dice table display 100 has a display area 104 for individual die cast outcomes with totals from between and including 2 through 12. in a craps game after a first cast or roll of the dice. The casino dice table display 100 has a display area 108 showing a first dice outcome from the game (in this case a “5” total. The other two display areas 110 and 112 for later individual dice outcomes from the underlying craps (or Sic Bo) game outcomes. Area 114 provides a running collective total of all outcomes on an ongoing side bet according to the present invention.

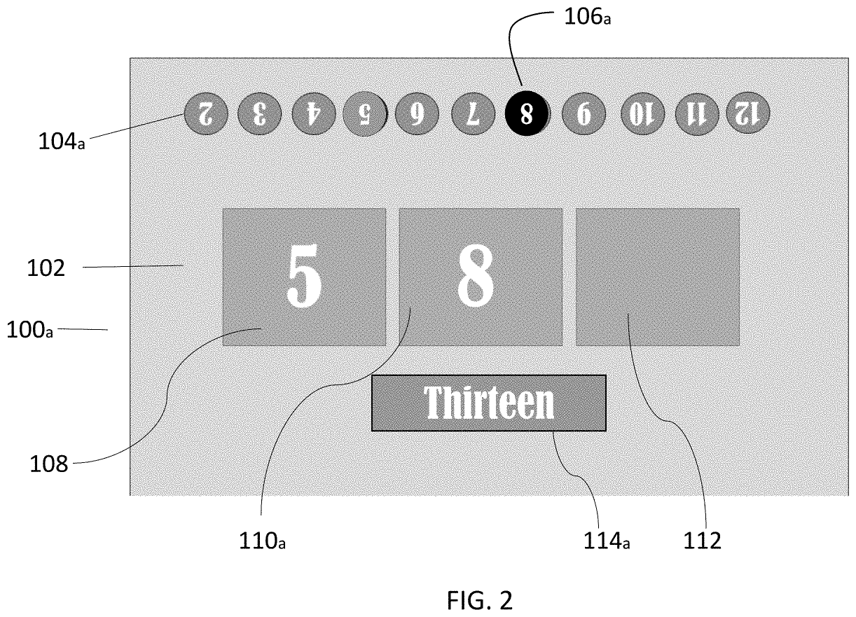

FIG. 2 shows a casino dice table display 100a having a first display area 102 for all side bet outcome information after a second cast of the dice. The casino dice table display 100a has a display area 104a for individual die cast outcomes with totals from between and including 2 through 12. in a craps game after a second cast or roll of the dice. The casino dice table display 100a has a display area 108 showing a first dice outcome from the game (in this case a “5” total). The other two display areas 110a shows the second dice outcome (an “8” total) and 112 for a later individual dice outcomes from the underlying craps (or Sic Bo) game outcomes. Area 114a provides a running collective total of all outcomes (in this case a “13”) on an ongoing side bet according to the present invention.

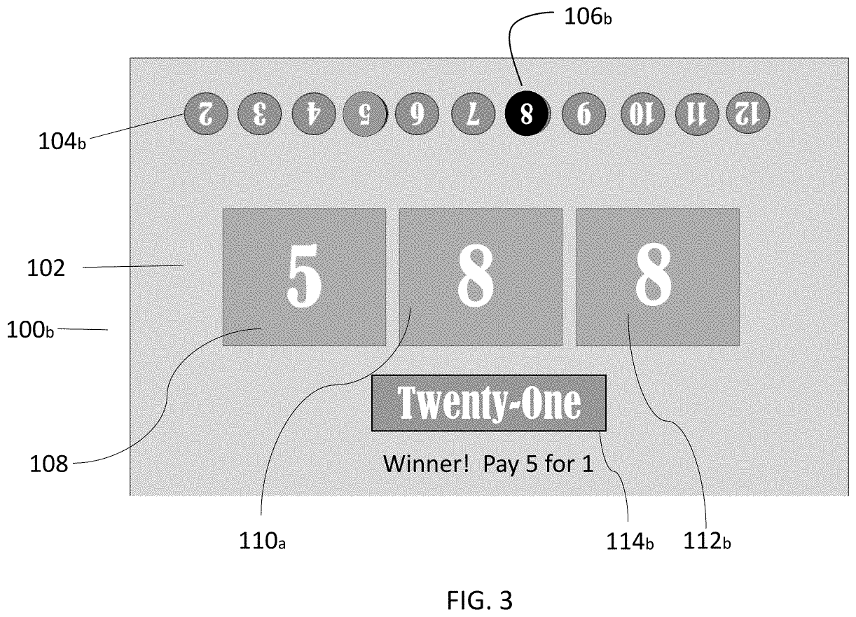

FIG. 3 shows a casino dice table display 100b in a craps game after a third cast or roll of the dice and a winning outcome. The casino dice table display 100b having a first display area 102 for all side bet outcome information after a second cast of the dice. The casino dice table display 100b has a display area 104b for individual die cast outcomes with totals from between and including 2 through 12. in a craps game after a third cast or roll of the dice. The casino dice table display 100b has a display area 108 showing a first dice outcome from the game (in this case a “5” total). The other two display areas 110a shows the second dice outcome (an “8” total) and 112b for a later individual dice outcomes from the underlying craps (or Sic Bo) game outcomes. Area 114b provides a running collective total of all outcomes (in this case a winning outcome of “21”) on an ongoing side bet according to the present invention.

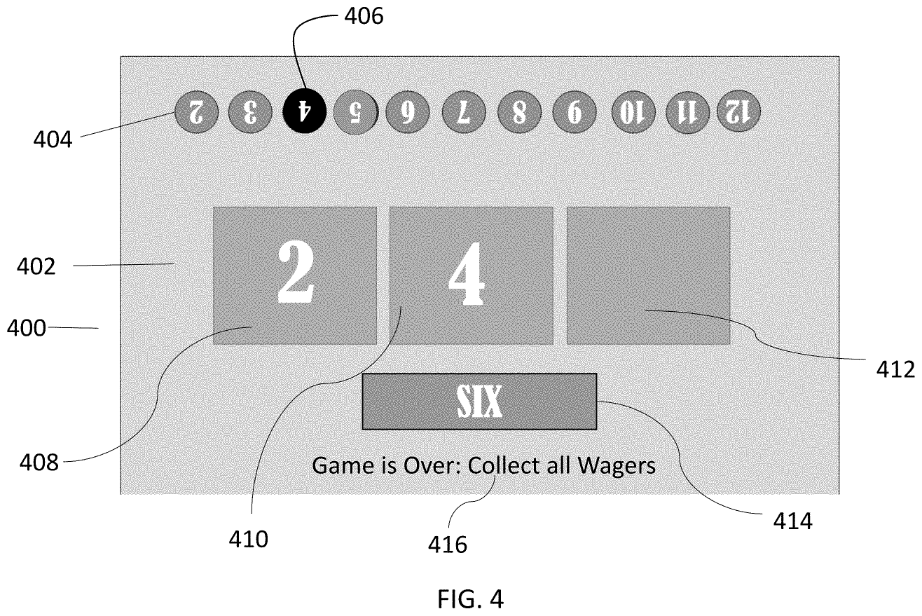

FIG. 4 shows a casino dice table display 400 in a craps game after a second cast or roll of the dice provides a total count 414 which is a losing outcome as its total cannot act in the next roll outcome to provide a winning outcome according to the rules (i.e., no third outcome can equal a total of 21 for all outcomes). The casino dice table display 400 having a first display area 402 for all side bet outcome information after a second cast of the dice. The casino dice table display 400 has a display area 404 for individual die cast outcomes with totals from between and including 2 through 12. in a craps game after a second cast or roll of the dice. The casino dice table display 400 has a display area 408 showing a first dice outcome from the game (in this case a “2” total). The other two display areas 410 shows the second dice outcome (a “4” total) and 412 for a later individual dice outcomes from the underlying craps (or Sic Bo) game outcomes. Area 414 provides a running collective total of all outcomes (in this case a “6”) on an ongoing side bet according to the present invention. Message 416 indicates that no net roll is able to win and the side bet event is an immediate loss, even before a third roll of the dice in the underlying craps game.

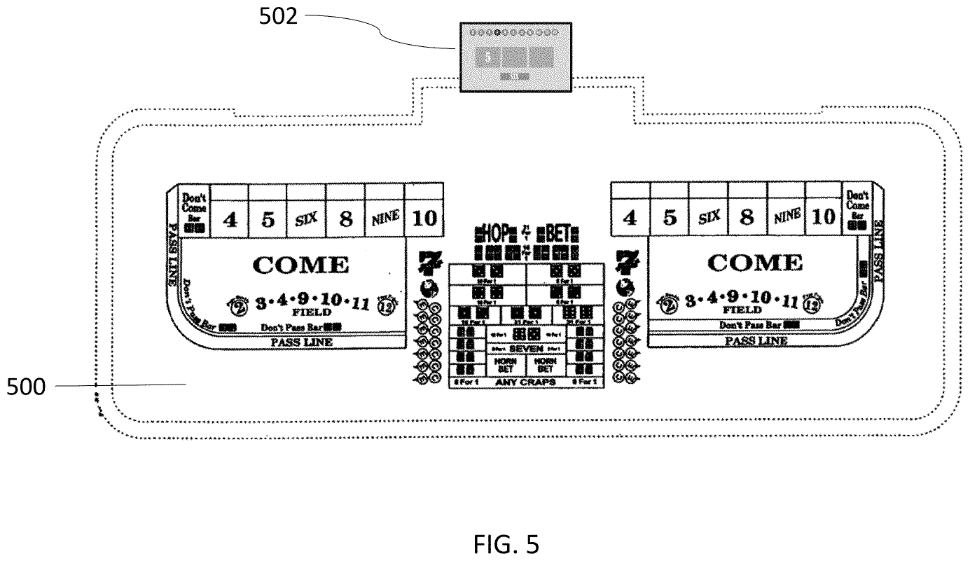

FIG. 5 shows a craps table 500 with a display element 502 disposed for view by all players at the craps table for outcomes in a side bet wagering event according to the present invention.

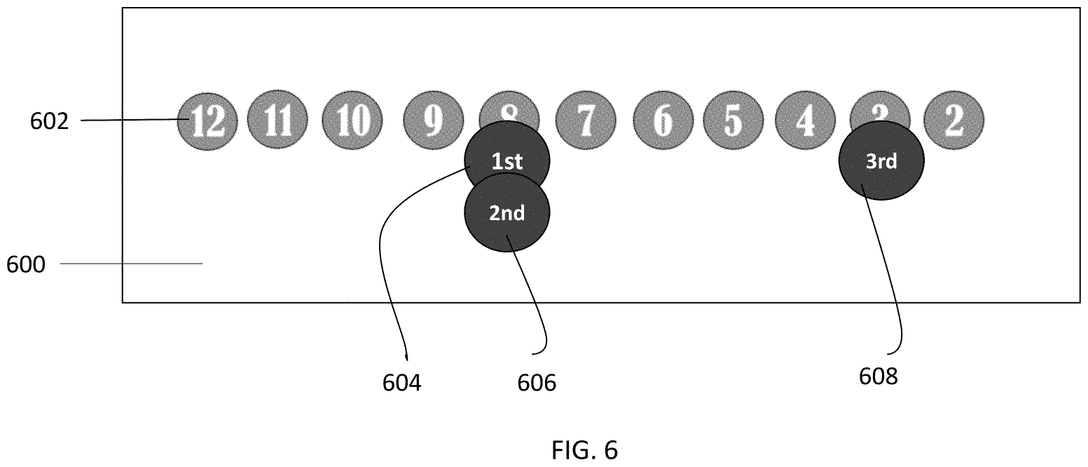

FIG. 6 shows a lammer or virtual lammer display system 600 for use according to the present gaming technology. There is again a line of markings 602 on the table for possible individual dice outcome totals between and including 2 through 12. There are three individual lammers 604, 606 and 608 respectively showing individual dice outcomes of “8,”, “8” and “3” for the first three dice outcomes.

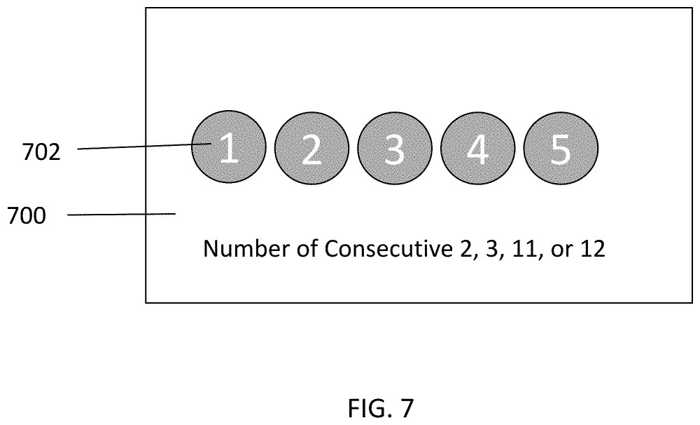

FIG. 7 shows a display panel 700 for an alternative or additional super event side bet accounting display with an indication of five consecutive dice outcomes 702 of five consecutive dice outcomes of any combination of 2, 3, 11 and 12.

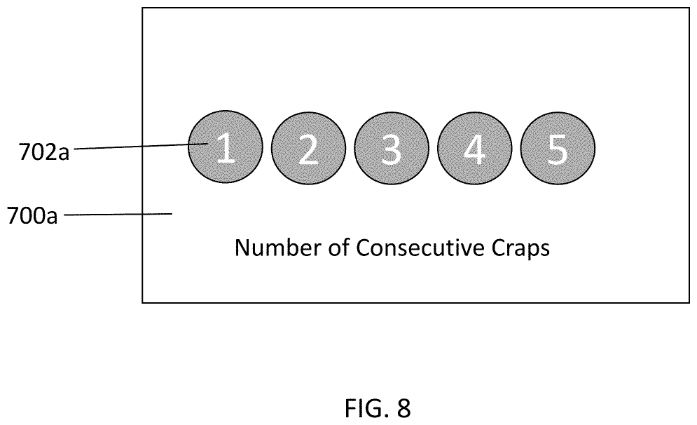

FIG. 8 shows a display panel 700a for a further alternative or additional super event side bet accounting display with an indication of four consecutive dice outcomes 702a of four consecutive dice outcomes of any combination of 2, 3 and 12.

An example of paytables on the side bet can include:

| | | |
|---|---|---|
| 3 Roll 21 | Pays | 5 for 1 |
| 2 Roll 21 | Pays | 15 for 1 |
| 7.7.7. Rolls | Pays | 50 for 1 |

| | | |
|---|---|---|
| 3 Roll 21 | Pays | 4-6 for 1 |
| 2 Roll 21 | Pays | 12-20 for 1 |
| 7.7.7. Rolls | Pays | 30-60 for 1 |

| | | |
|---|---|---|
| 3 Roll 21 | Pays | 5 for 1 |
| 2 Roll 21 | Pays | 15 for 1 |
| Four Consecutive Craps | Pays | 75 for 1 |
| Rolls (2, 3 or 12) | | |

| | | |
|---|---|---|
| 3 Roll 21 | Pays | 5 for 1 |
| 2 Roll 21 | Pays | 15 for 1 |
| Four Consecutive Rolls | Pays | 50 for 1 |
| (2, 3, 11 or 12) | | |

The specific payouts are approximates, as shown in the second table. These are presently representative examples of the paytables.

What is claimed:

1) A method of executing a side bet wagering event during multiple rounds of play in a dice game of craps or Sic Bo games comprising:
a) a player placing a side bet before a round of play in the dice game;
b) the side bet wager indicating an amount of the side bet wager, a specific player making the wager and a position within the multiple rounds of play in the casino dice game;
c) the side bet wager being resolved by outcomes in from 2-7 casts of dice during the multiple rounds of play in the casino dice game, at least one winning outcome paid against a paytable for achieving:
i) a cumulative total of exactly twenty-one with the two dice used in craps;
ii) a higher number than twenty-one (such as 30-36) with the three dice used in Sic Bo from the outcomes in from 2-7 casts of dice during the multiple rounds of play in the casino dice game;
iii) at least four consecutive rolls of craps selected from any combination of 2, 3 and 12 as outcomes; and/or
iv) at least five consecutive rolls of craps selected from any combination of 2, 3 and 12 as outcomes or 11.

2) The method of claim 1 wherein identification is made by a special marker on a gaming table being used during the multiple rounds of play in a casino craps game to indicate when a specific player places a side bet before a specific round of play during the multiple rounds of play in the casino craps game.

3) The method of claim 1 wherein a count total system visually indicates running totals for more than one consecutive round of play at a single time.

4) The method of claim 2 wherein the cumulative total of exactly twenty-one from the outcomes in exactly 2, 3 or 4 casts of dice during the multiple rounds of play in the casino craps game.

5) The method of claim 2 wherein the paytable includes an award for a cumulative total of exactly 21 by three consecutive casts having a total of exactly 7 with each cast.

6) The method of claim 2 wherein the multiple rounds of play in the casino craps game are executed with physical dice on a physical gaming table and a physical marker indicates, by number, each specific cast outcome.

7) The method of claim 2 wherein the multiple rounds of play in the casino craps game are executed with physical dice on a physical gaming table and an electronic display marker indicates, by number, each specific cast outcome.

8) The method of claim 3 wherein the multiple rounds of play in the casino craps game are executed with physical dice on a physical gaming table and a physical marker indicates, by number, each specific cast outcome.

9) The method of claim 2 herein the multiple rounds of play in the casino craps game on an electronic gaming table in which either physical dice are automatically cast or virtual dice are virtually cast and a panel marker indicates, by number, each specific cast outcome.

10) The method of claim 1 wherein the side bet wagering event during multiple rounds of play in a dice game of Sic Bo comprising:
d) a player placing a side bet before a round of play in the Sic Bo dice game;
e) the side bet wager indicating an amount of the side bet wager, a specific player making the wager and a position within the multiple rounds of play in the Sic Bo dice game;
f) the side bet wager being resolved by outcomes in from 2-7 casts of three dice during the multiple rounds of play in the Sic Bo dice game, at least one winning outcome paid against a paytable for achieving a cumulative total of a specific number of between 27-36 with the three dice used in Sic Bo from the outcomes in from 2-7 casts of dice during the multiple rounds of play in the Sic Bo dice game.

11) The method of claim 10 wherein identification is made by a special marker on a gaming table being used during the multiple rounds of play in a casino Sic Bo game to indicate when a specific player places a side bet before a specific round of play during the multiple rounds of play in the casino Sic Bo game.

12) The method of claim 10 wherein a count total system visually indicates running totals for more than one consecutive round of play at a single time.

13) The method of claim 11 wherein the cumulative total of exactly twenty-one from the outcomes in exactly 2, 3 or 4 casts of dice during the multiple rounds of play in the casino Sic Bo game.

14) The method of claim 11 wherein the paytable includes an award for a cumulative total of exactly 27, 30, 33, or 36 by three consecutive casts having a total of exactly 9, 10, 11 or 12, respectively, with each cast of three dice.

15) The method of claim 11 wherein the multiple rounds of play in the casino Sic Bo game are executed with physical dice on a physical gaming table and a physical marker indicates, by number, each specific cast outcome.

16) The method of claim 11 wherein the multiple rounds of play in the casino Sic Bo game are executed with physical dice on a physical gaming table and a electronic display marker indicates, by number, each specific cast outcome.

17) The method of claim 12 wherein the multiple rounds of play in the casino craps game are executed with physical dice on a physical gaming table and a physical marker indicates, by number, each specific cast outcome.

18) The method of claim 11 herein the multiple rounds of play in the casino craps game on an electronic gaming table in which either physical dice are automatically cast or virtual dice are virtually cast and a panel marker indicates, by number, each specific cast outcome.
